(19) United States
(12) Patent Application Publication
(10) Pub. No.: US 2014/0089775 A1
(43) Pub. Date: Mar. 27, 2014

(54) Synchronizing Book Annotations With Social Networks

(71) Applicants: Frank R. Worsley, San Francisco, CA (US); Abraham P. Murray, Scituate, MA (US); Ryan Wolf, Laguna Beach, CA (US); Kevin Landry, Irvine, CA (US)

(72) Inventors: Frank R. Worsley, San Francisco, CA (US); Abraham P. Murray, Scituate, MA (US); Ryan Wolf, Laguna Beach, CA (US); Kevin Landry, Irvine, CA (US)

(21) Appl. No.: 13/629,556

(22) Filed: Sep. 27, 2012

(51) Int. Cl. G06F 17/00; G06F 15/16

(52) U.S. Cl. 715/230

(57) ABSTRACT

Annotated electronic book (ebook) content is provided at a client device. A request for an annotation is received from the client device. The request identifies an ebook and a portion of the ebook for which the annotation is requested. A corresponding post on a social network that contains content for the annotation that also corresponds to the identified portion of the ebook is identified. The content contained by the identified post is transmitted to the client device, with the client device being adapted to display the content contained by the identified post in association with the portion of the ebook for which the annotation was requested.

### BACKGROUND

1. Technical Field

The subject matter described herein generally relates to the field of electronic books and in particular to community-based annotation.

2. Background Information

Electronic books (“ebooks”) come in a variety of formats (e.g., IDPF/EPUB and PDF) and can be read using a variety of devices (e.g., dedicated reading devices and general-purpose mobile devices, tablet computers, laptop computers, and desktop computers). Each device includes reading software (“ereader”) that displays an ebook to a user. An ereader that enables a user to interact with an ebook is generally specific to a particular device, a particular ebook format, and/or a particular ebook.

Book-reading can be a social activity. For example, a group of readers may form a book club to read the same book at the same time. Such book clubs, in the case of paper books, typically have regular meetings to discuss the book as they read. As another example, students often form study groups and discuss portions of set texts and/or textbooks. In the case of ebooks, technology provides opportunities to enhance the social reading experience that are not realized by existing systems.

### SUMMARY

The above and other problems are addressed by a method, computer-readable storage medium, and computer for supporting annotated electronic book (“ebook”) content. An embodiment of the method comprises receiving, from a client device, a request for an annotation, the request identifying an ebook and a portion of the ebook for which the annotation is requested. The method also comprises identifying a post on a social network containing content for the annotation, the post corresponding to the identified portion of the ebook. The method further comprises transmitting the content contained by the identified post to the client device, wherein the client device is adapted to display the content contained by the identified post in association with the portion of the ebook for which the annotation is requested.

An embodiment of the computer system for supporting annotated electronic book (“ebook”) content includes a non-transitory computer-readable storage medium storing executable computer code. The computer program code comprises instructions for receiving, from a client device, a request for an annotation, the request identifying an ebook and a portion of the ebook for which the annotation is requested. The computer program code also comprises instructions for identifying a post on a social network containing content for the annotation, the post corresponding to the identified portion of the ebook. The computer program code further comprises instructions for transmitting the content contained by the identified post to the client device, wherein the client device is adapted to display the content contained by the identified post in association with the portion of the ebook for which the annotation is requested. The computer system further includes a processor for executing the computer program code.

An embodiment of the non-transitory computer-readable storage medium stores executable computer program code for supporting annotated electronic book (“ebook”). The executable computer program code comprises instructions for receiving, from a client device, a request for an annotation, the request identifying an ebook and a portion of the ebook for which the annotation is requested. The executable computer program code also comprises instructions for identifying a post on a social network containing content for the annotation, the post corresponding to the identified portion of the ebook. The executable computer program code further comprises instructions for transmitting the content contained by the identified post to the client device, wherein the client device is adapted to display the content contained by the identified post in association with the portion of the ebook for which the annotation is requested.

### BRIEF DESCRIPTION OF THE DRAWINGS

FIG. 1 is a high-level block diagram illustrating an environment for providing a framework for synchronizing electronic book annotations with associated social network posts, according to one embodiment.

FIG. 2 is a high-level block diagram illustrating an example of a computer for use as a repository, a processing server, and/or a client device, according to one embodiment.

FIG. 3 is a sequence diagram illustrating steps involved in transferring ebook information according to one embodiment.

FIG. 4 is a sequence diagram illustrating steps involved in transferring layer information according to one embodiment.

FIG. 5 is a high-level block diagram illustrating the social network module of the processing server shown in FIG. 1, according to one embodiment.

FIG. 6 is a flowchart illustrating a method for creating an annotation that is synchronized between an ereader environment and a social network, according to one embodiment.

FIG. 7 is a flowchart illustrating a method for supporting annotated ebook content, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

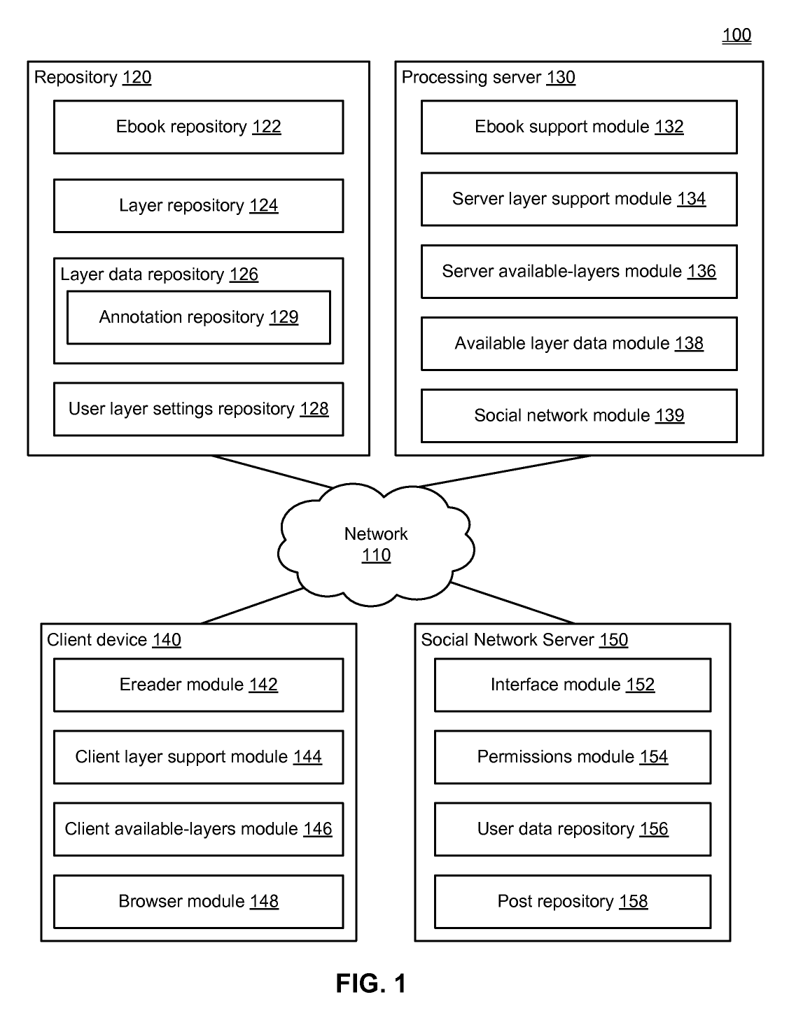

FIG. 1 is a high-level block diagram illustrating an environment 100 for providing a framework for synchronizing electronic book (“ebook”) annotations with associated social network posts and comments according to one embodiment. The environment 100 may be maintained by an enterprise that enables interaction with electronic books, such as a corporation, university, or government agency. As shown, the environment 100 includes a network 110, a repository 120, a processing server 130, a social network server 150, and a client device 140. While only one of each entity is shown in the embodiment depicted in FIG. 1 for clarity, other embodiments can have multiple repositories 120, processing servers 130, social network servers 150, and/or client devices 140. Alternatively, one or more of the entities may be combined and provided by a single computing device. Further, the functionality attributed to various entities and modules herein may be distributed between entities and modules in a different manner.

The network 110 represents the communication pathway between the repository 120, the processing server 130, and the client device 140. In one embodiment, the network 110 uses standard communications technologies and/or protocols and can include the Internet. Thus, the network 110 can include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 110 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), etc. The data exchanged over the network 110 can be represented using technologies and/or formats including image data in binary form (e.g. Portable Network Graphics (PNG)), hypertext markup language (HTML), extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities on the network 110 can use custom and/or dedicated data communications technologies instead of, or in addition to, the ones described above.

The client device 140 is used by a user to interact with an ebook. The client device 140 includes an ereader module 142 that enables the user to view the ebook, a client layer support module 144 that enables an ereader tool (“layer”) to be used to interact with the ebook, a client available-layers module 146 that determines which layers are available to interact with particular ebook content, and a browser module 148 used to access web-based content (e.g., a social network website provided by the social network server 150). Other embodiments of the client device 140 include different and/or additional modules. In addition, the functions may be distributed among the modules in a different manner than described herein.

The ereader module 142 enables a user to view and/or read an ebook. The ereader module 142 also communicates with the ebook support module 132 to obtain ebooks that are stored in the ebook repository 122. In one embodiment, the ereader module 142 is a JavaScript program that executes on the client device 140 in conjunction with a web browser (also executing on the client device).

The client layer support module 144 enables a layer to be used to interact with an ebook. The client layer support module 144 also communicates with the server layer support module 134 to obtain layer information that is stored in the layer repository 124 and the layer data repository 126.

A layer enhances the functionality of the ereader module 142 by enabling a user to interact with an ebook that is being presented by the ereader module. Specifically, a layer enables a user to interact with particular ebook content. The particular ebook content could be, for example, content that is associated with “layer data” (e.g., user comments relating to other content of the ebook, a type of layer data) or content that the user has activated, where “activated” means indicated in some way, such as by selecting, clicking, tapping, or hovering over. In this way, a layer adds contextually useful interactivity to the ebook. The particular ebook content may be text, an image, an audio clip, and/or other embedded content, and the content in the annotations layer may also be made up of text, images, audio clips and/or other types of content. In one embodiment, layers provide additional contextual information about entities (e.g., people, places, organizations, and the like) referenced in the text of an ebook. In one embodiment, multiple types of content can be interacted with simultaneously.

A layer is able to display information associated with the ebook, such as information from the ebook, information from layer data, and/or information generated based on ebook information and/or layer data information. A layer is able to store data and associate it with particular ebook content. The data is referred to as an “annotation”, and the ebook content with which the data is associated is referred to as “annotated content.” An existing annotation can be obtained from the annotation repository 126, and a new annotation can be created by a layer (e.g., due to user interaction with the layer).

Layers can provide various types of functionality for interacting with ebook content. Layers can be created by anyone, such as third parties and/or book publishers. Some layers apply to ebook content in general. Exemplary layers of this type include Margin Notes, Define, Translate, Search Book, Search Internet, and Search Encyclopedia.

One such layer is a Margin Notes layer. The Margin Notes layer enables a user to highlight and/or add a note to content in an ebook. The user activates content in the ebook and then uses the Margin Notes layer to highlight the activated content (in any of a variety of colors) and/or enter information (a “note”) to associate with the activated content. The user specifies a desired highlight color by selecting a displayed color (e.g., yellow, green, pink, or blue) or using a default color (e.g., yellow). The note information can include, for example, typed characters, a URL, handwritten information, or multimedia (e.g., a still image, a video, or audio). If particular ebook content is already associated with a note, then activating that content will cause the note to be displayed. The displayed note can then be edited or deleted if desired. The highlight color and the note information are examples of information stored in an annotation.

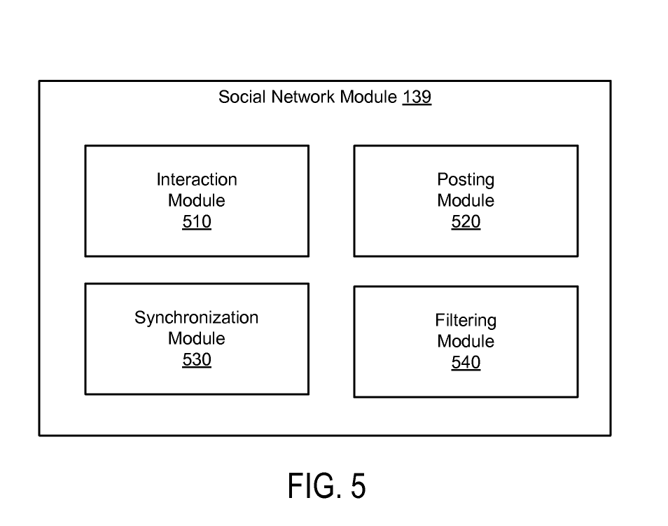

In one embodiment, the user can share an annotation in a Margin Notes layer to a social network, either at the time the annotation is created and/or after the fact. The shared annotation is then synchronized with a corresponding social network post. For example, a member of a book club could add a chapter review as an annotation and then share the annotation with the other members of the book club via a social network group (e.g., a GOOGLE+CIRCLE™). As the annotation and social network post are synchronized, any comments made by other members of the book club on the social network will also appear in the user's ebook as corresponding to the annotation. Further, as the annotation has been shared, the annotation (and any associated comments) can also be displayed in the ebooks of the other members of the group. In one embodiment, when a user requests to download an ebook, some or all of the annotation content corresponding to the ebook is also requested. The ebook and corresponding annotation content are thus downloaded to the user's ereader substantially concurrently. The annotation content stored on the ereader for the ebook is updated periodically, for example, once an hour, or each time the user opens the ebook. Synchronization between annotations and social network posts is described in greater detail below, with reference to FIG. 5.

In some embodiments, more than one layer can be used at the same time and/or multiple instances of the same layer can be used at the same time (e.g., for different activated or annotated ebook content). Also, multiple layers can display information simultaneously. In another embodiment, layers cannot interact with each other. While multiple layers can be used simultaneously (possibly for the same activated or annotated content), the layers cannot access each other's data.

In one embodiment, the client layer support module 144 includes functionality related to enabling/disabling layers, launching layers, indicating the presence of layer data, and providing an application programming interface (API) to layers. Regarding enabling/disabling layers, the client layer support module 144 enables a user to enable/disable layers. Enabled layers can be provided as options in a layer menu (e.g., a popup menu), while disabled layers cannot. Also, layer data (e.g., annotations) associated with enabled layers can be displayed automatically. In one embodiment, a user can designate an enabled layer as “automatic-launch,” which causes the layer to be launched when the ereader module 142 displays ebook content associated with relevant layer data. In another embodiment, a graphical user interface lists “installed” layers (indicated by the user layer settings repository 128), and the user enables/disables these layers (and possibly marks them as “automatic-launch”) by checking/unchecking various boxes. These settings are then stored and made available by the client layer support module 144.

Regarding launching layers, the client layer support module 144 launches a layer (i.e., creates an instance of a layer) so that a layer module is executed by the client device 140. An instance of a layer (e.g., content dynamically rendered by a layer) is displayed within the ereader module's main window or displayed by a separate application (e.g., a web browser invoked with a URL or a map application invoked with an address). In one embodiment, a layer can be displayed in various modes, such as overlay (floating above an entire page of ebook content), replace (floating above particular ebook content, thereby “hiding” the ebook content), side panel (present in a side panel adjacent to the ebook content, possibly in the form of a small preview that can be interacted with), and margin (present in a margin area of the ebook content, possibly in the form of a very limited preview). The ereader module 142 allocates a display area inside of which a layer can create user interface (UI) controls. The ereader module 142 instructs the layer to render itself into the appropriate display area and informs the layer of the context in which it is rendering itself (e.g., overlay, replace, side panel, or margin). The display area that is allocated depends on the layer's display mode. In one embodiment, a layer cannot modify the size of its display area, move the display area, or create UI elements outside of the display area. In another embodiment, a layer can request the properties of its display environment (e.g., display mode, display area size, display area location, and pinning status) and/or be notified of any changes.

In one embodiment, when the client layer support module 144 launches a layer, the client layer support module also sends layer usage data to the server layer support module 134. The server layer support module 134 then stores the layer usage data. In one embodiment, layer usage data includes a layer ID of the layer that was launched, a display mode in which the layer was launched, a user ID, an ebook ID, an associated (e.g., activated or annotated) content range, a type of the content range, ebook context, web browser information, and/or client device information. The associated content range indicates a portion of the ebook to which layer data corresponds, and can range in granularity from an entire ebook to a single pixel on a specific page of the ebook. The type of the content range can be a data type (e.g., text, image, video, or audio), an annotation type (e.g., the layer that created the annotation), or an entity type (e.g., date, person, or geographic location). In one embodiment, the client layer support module 144 notifies a user of the types of information that are collected and transmitted to the server layer support module 134 and provides the user the opportunity to opt-out of having such information collected and/or shared with the server layer support module 134.

Regarding indicating the presence of layer data (e.g., annotations or entity information), the client layer support module 144 can visually indicate ebook content (presented by the ereader module 142) that is associated with layer data. For example, the client layer support module 144 highlights or otherwise styles the ebook content that is associated with the layer data (referred to as “annotated content”). In one embodiment, the client layer support module 144 visually indicates only annotated content that is associated with an annotation whose associated layer is enabled and only entity content that is of a type where a relevant entity layer is enabled (e.g., a date-entity layer or a generic-entity layer). In this embodiment, the client layer support module 144 does not visually indicate annotated content that is associated with an annotation whose associated layer is disabled, nor does it indicate entity content that is of a type where all relevant entity layers are disabled.

In one embodiment, the display style of annotated content (“annotated content style”) is configurable from a fixed set of options. Options include, for example, simple formatting, display mode, and automatic layer launch. Simple formatting includes, for example, text style options (e.g., font, color, highlighting, italics, boldface, underlining, and outlining) and indicators (e.g., mini-icons or chiclets) that are displayed in the ebook margins or alongside ebook content to indicate that a particular type of layer has content available near that location. In one embodiment, annotated content (e.g., content with associated Margin Notes) is indicated in the page slider presented by the ereader module 142. This makes it easy for the user to return to a page with annotated content.

Display mode includes a default or preferred display mode in which to launch a particular layer (e.g., the layer associated with the annotation or a layer relevant to the entity type) (e.g., overlay, replace, side panel, or margin). Automatic layer launch specifies that a particular layer (e.g., the layer associated with the annotation that is associated with the annotated content or a layer relevant to the entity type) should be automatically launched when the annotated content is displayed by the ereader module 142. Note that simple formatting, display mode, and automatic layer launch can be used independently of each other. For example, if automatic layer launch is used without simple formatting, then the annotated content does not appear differently from non-annotated content; however, a layer is automatically launched when the annotated content is displayed.

Display styles can be set on a case-by-case basis, so different instances of ebook content associated with annotations saved by the same layer can be displayed differently (e.g., yellow highlighting versus green highlighting for different passages annotated by the same Margin Notes layer). Note that when an existing annotation is saved, the annotated content style of the layer data can be modified. For example, consider a Margin Notes layer that adds a user comment to a particular paragraph of an ebook. The annotated content style of Margin Notes layer data specifies that the annotated content does not appear differently from non-annotated content. However, when the annotated content is displayed for the first time after the user comment has been added, the Margin Notes layer is automatically launched in overlay mode (floating above the entire page of ebook content that contains the annotated content), and the user comment is displayed. Responsive to the Margin Notes layer being closed by the user, the annotated content style of the Margin Notes layer data is updated. The updated style specifies that the next time the annotated content is displayed; the Margin Notes layer is not automatically launched. Instead, an icon is displayed in the margin that can be used to access the inscription stored in the annotation portion of the Margin Notes layer data.

Note that layer data must exist on the client device 140 before the layer data can be displayed. However, layer data may include references and/or links to remote content to be accessed via the network 110 and displayed on the client device 140. In one embodiment, layer data is transferred from the repository 120 to the client device 140 (via the processing server 130 and the network 110) in response to a request from the client layer support module 144.

In one embodiment, a layer cannot draw its own style for annotated content. In this embodiment, the client layer support module 144 indicates annotated content using a configurable style (e.g., chosen by the user). In another embodiment, layer data can specify its own style for annotated content. For example, the annotated content style is indicated by the Style data item (see Table 1 further discussed herein).

A layer can access the ebook content for which it was launched (e.g., activated content or annotated content) and also a context object. A context object is a data structure that stores information about a particular ebook's context. In one embodiment, the context object includes only context that is local to the ebook and the user's interaction with the ebook. Local context includes, for example, ebook title, author, publisher, indication of currently-displayed portion of ebook (e.g., chapter number and page number), indication of current ebook display mode (e.g., flowing text versus scanned image), and device capabilities. In another embodiment, additional context is provided such as related books, most popular pages in the ebook, etc.

In one embodiment, a Layer API is provided that enables a layer to specify an annotated content style to use when displaying the layer contents. In another embodiment, a generic UI control is provided by the ereader module 142 so that the user can specify the annotated content style. In this UI, the user can specify “use this display style for the current annotated content only” or “use this display style for all content in this layer.” In yet another embodiment, a layer can indicate whether a generic UI control should be displayed to specify annotated content style or whether the layer will provide its own UI controls to specify annotated content style. In a further embodiment, layers can indicate a default display style but a generic UI control is also provided. The layer contents are displayed with the default style unless the user overrides the default using the generic UI control.

Table 1 shows data items that are stored for each instance of layer data according to one embodiment.

TABLE 1

| Data Item Name | Data Item Description |
|---|---|
| Volume ID | the volume (ebook) the layer data is for |
| Layer ID | the layer the layer data is for |
| User ID | the user ID of the owner |
| ACL | the permissions for the layer data |
| Page ID | the multiple page IDs the layer data can span |
| Before Text | the text before the associated (activated or |
| | annotated) ebook content (if any) |
| After Text | the text after the associated (activated or |
| | annotated) ebook content (if any) |
| Associated Ebook Text | the text portion (if any) of the associated |
| | (activated or annotated) ebook content |
| Style | the style information for associated |
| | (activated or annotated) ebook content (e.g., |
| | simple formatting and/or automatic layer |
| | launch; “annotated content style”) |
| Data | the data to store for the layer (for user |
| | interaction purposes; “annotation”) |
| Client Sent Range | start/end position and start/end offset for |
| Association | multiple position types (text, image, |
| | canonical fragment indicators (CFI), EPUB |
| | marker); the range information, including |
| | content version, of where the associated |
| | (activated or annotated) content is exactly |
| | located for the specified version of the |
| | volume when this layer data was last created |
| | or modified as sent by the client |
| Current Range | same as Client Sent Range Association but |
| Association | for current volume version; the current range |
| | information, including the current content |
| | version, of where the associated (activated or |
| | annotated) content is exactly located for the |
| | specified version of the volume when this |
| | layer data was last created or modified |
| Current Volume Version | current version of the volume |
| Scanjob Information | helpful when moving the layer data because |
| | of content shifting (e.g., between volume |
| | versions) |
| Last Modified | timestamp of last modification for this layer |
| | data |
| Created | timestamp of when layer data was created |

In one embodiment, the Style data item in Table 1 is implemented as a dictionary object of name/value pairs for the different style attributes. The dictionary object is represented as a JSON object in JavaScript. In one embodiment, layer data can be queried by using the following parameters: a) user, b) user and volume (and possibly also page id(s)), and c) user, volume, and layer id (and possibly also page id(s)).

The client available-layers module 146 determines which layers are available to interact with activated ebook content. Specifically, the client available-layers module 146 takes as input a list of available layers (output by the server available-layers module 136), activated content, and a list of enabled layers and outputs a list of layers that are available for interacting with the activated content. The client available-layers module 146 compares the list of available layers to the list of enabled layers to determine a list of possible layers (i.e., layers that are both available and enabled). The type of the activated content is then compared to the possible layers (specifically, to the layers' metadata, which specifies what type of ebook content can be interacted with using each layer). The type of the activated content can be a data type (e.g., text, image, video, or audio), an annotation type (e.g., the layer that created the annotation), or an entity type (e.g., date, person, or geographic location). The client available-layers module 146 outputs the matching layers as a list. Note that this list of layers is activated-content-specific.

The repository 120 is a computer (or set of computers) that stores an electronic book (“ebook”) repository 122, an ereader tool (“layer”) repository 124, a layer data repository 126, and a user layer settings repository 128. In one embodiment, the repository 120 includes a server that provides the processing server 130 access to the ebook repository 122, layer repository 124, layer data repository 126, and user layer settings repository 128 in response to requests. Other embodiments of the repository 120 include different and/or additional modules. In addition, the functions may be distributed among the modules in a different manner than described herein.

The ebook repository 122 stores a corpus of ebooks. In one embodiment, an ebook adheres to the JavaScript Object Notation (JSON) format. An ebook includes content and metadata. Ebook content includes an electronic collection of text (and possibly additional types of content such as images and/or sound). For example, ebook content includes content of a book such as would be printed on the pages of a traditional paper-based book. All of the text in the collection may be from a single source, or the collection may contain text from different sources. The text may have originated in a traditional paper-based format (e.g., a physical book or newspaper), or it may have originated in a digital format (e.g., electronic files in a format such as Portable Document Format (PDF), EPUB format, or flowing text format). The content of an ebook is divided into segments so that portions of the content can be transferred and/or loaded separately. For example, an ebook can include one segment for each chapter. In one embodiment, ebook content includes files that adhere to the HTML format, the Cascading Stylesheets (CSS) format, and various multimedia formats (e.g., audio files, image files, and video files).

Ebook metadata includes bibliographical information about an ebook, such as the title, author, publication date, number of pages, number of chapters, etc. Ebook metadata also includes a list of segments into which the ebook's content is divided. A segment is represented on the list by, for example, a unique identifier. In one embodiment, ebook metadata also includes a blacklist, a whitelist, and/or an add-list. These lists control which layers can be used with an ebook. A blacklist specifies layers that cannot (i.e., are not allowed to) be used with a particular ebook. A whitelist specifies layers that can (i.e., are allowed to) be used with a particular ebook. An add-list specifies layers that are recommended to be used with a particular book. For example, an ebook publisher can require that a particular ebook be interacted with in accordance with a particular blacklist, whitelist, and/or add-list. A layer is represented on a list by, for example, a unique identifier.

The layer repository 124 stores various layers. As described previously, a layer includes executable code and metadata. A layer enables a user to interact with an ebook that is being presented by the ereader module. Specifically, a layer enables a user to interact with particular ebook content (e.g., content that the user has activated or content that is associated with layer data). The particular content may be text, an image, or other embedded content. In one embodiment, multiple types of content can be activated simultaneously. In one embodiment, a layer module is implemented as a JavaScript program.

Layer metadata specifies what type of ebook content a particular layer is applicable to (i.e., what type of content can be interacted with using a particular layer). The type of the ebook content can be a data type (e.g., text, image, video, or audio), an annotation type (e.g., the layer that created the annotation), or an entity type (e.g., date, person, or geographic location). For example, a first layer can enable interaction with only textual content, while a second layer can enable interaction with only graphical content. Layer metadata also specifies which display modes (e.g., overlay, replace, side panel, and/or margin) are supported by the layer, possibly designating one of the supported display modes as the default or preferred display mode.

The module of a particular layer must exist on the client device 140 before the layer instance can be launched. In one embodiment, the layer module is transferred from the repository 120 to the client device 140 (via the processing server 130 and the network 110) when the list of available layers is received by the client device. For example, the modules of all available layers are transferred or the modules of only the “installed” available layers (as indicated in the user layer settings repository 128) are transferred. In another embodiment, the layer module is transferred when an attempt is made to launch the layer, either manually (e.g., using a popup menu) or automatically (e.g., based on layer data). For example, the client layer support module 144 detects the attempt and, in response, sends a request to the server layer support module 134 (via the network 110) for the relevant layer module. The server layer support module 134 receives the request and, in response, sends the relevant layer module to the client layer support module 144 (via the network 110). In other embodiments, the layer module is transferred at other suitable times (e.g., when the ereader module 142 is initially installed on the client device 140).

Note that the layer module can already be present on the client device 140 due to having been transferred in the past. In one embodiment, a layer module on the client device is deleted after the ereader module 142 ceases executing. In another embodiment, a layer module on the client device remains on the client device even after the ereader module ceases executing. If a layer module remains, the module can be updated later on as necessary (e.g., as indicated by a module version number).

Regarding how a layer is implemented, and how client-side code can execute a layer, in one embodiment, an extensible framework for layers includes the following features: 1) An XML file format for packaging a layer's HTML, JavaScript, and application descriptor into a single file. The application descriptor indicates which types of ebook content the layer is applicable to. 2) A service that renders a layer XML file into HTML/JavaScript that can be displayed in a web browser. 3) Client-side JavaScript for existing web applications (e.g., ereader module 142 and/or client layer support module 144) to instantiate layers and display them inside a container element. The JavaScript creates sandboxed iframe HTML elements for each layer. The iframes use uniform resource locators (URLs) that point back to the service to render the requested layer. 4) Client-side JavaScript for a remote procedure call (RPC) framework that enables applications (e.g., ereader module 142 and/or client layer support module 144) to register JavaScript methods (the Layer API) that the layers can call from their sandboxed iframes. This enables layers to call back into the application and send/receive data. Also, executing a layer in an isolated iframe prevents the layer from interfering with the operation of the ereader module 142. 5) The ability to bundle RPC methods into a user interface extension (UIX) “feature.” A Books feature exposes books-specific APIs (the Layer API) to the layers via the RPC framework. A layer can indicate in its application descriptor which features it requires to execute.

The layer data repository 126 includes information concerning data that is used by a layer (e.g., to display to the user when the layer is launched). In one embodiment, the data was created by a layer during execution of the layer, (e.g., user added comments in a Margin Notes layer). In another embodiment, the data was created before the layer was ever executed. For example, the creator of a layer that is meant to display study guide text would also create layer data with the actual study guide text. This layer data would exist before the study guide layer was ever executed and would be available to users of the study guide layer.

Layer data is associated with particular ebook content. Recall that a layer enables a user to interact with particular ebook content (e.g., content that the user has activated or content that is associated with layer data). Data that is stored by a layer (e.g., a “note” added by a user with the Margin Notes layer) is associated with the particular ebook content that was activated or annotated when the layer was launched. If, at a later time, the same layer is launched with respect to the same ebook content, then the layer will load its previously stored data. This data is known as an annotation and is stored in an annotation repository 129.

In one embodiment, layer data stored in the annotation repository 129 includes three elements: an indication of a range of ebook content (e.g., an ebook identifier that identifies a specific ebook and an indication of a portion of that ebook to which the annotation corresponds), a type (e.g., an indication of the particular layer that created the layer data), and an annotation (the data that a layer stores and retrieves for user interaction purposes; e.g., a “note” added by a user with the Margin Notes layer). The content range includes any type of ebook content, such as text and/or multimedia (e.g., audio, still images, and/or video). The location of the content range includes, for example, an ebook indicator (e.g., a volume ID), a page indicator (e.g., a page ID), and a position range that includes a start position and an end position. Thus, a particular portion of a particular ebook can be uniquely identified. Each position is an internal marker for a position within an ebook and includes, e.g., a paragraph indicator and an offset within that paragraph. In a graphic novel where there is no text, a position can be specified for each image. The image positions can be used to determine where a content range starts and/or ends so that images within the content range can be indicated. In one embodiment, multiple position types are supported (e.g., text, image, canonical fragment indicators (CFI), EPUB markers, and/or arrays of bounding boxes). The indication of the particular layer that created the layer data is, for example, a layer identifier (“ID”). In one embodiment, each instance of layer data is associated with only one layer (i.e., the layer that created the layer data instance). In further embodiments annotations also include an indication of annotation authorship (e.g., a user ID), and information regarding access permissions for the layer data.

An ebook can be updated frequently, resulting in different versions with different content locations. Content locations between these different versions should be translated so that layer data can be associated with the correct ebook content. In one embodiment, a position validation service performs this translation.

For example, assume that a client device 140 requests layer data for a particular page of an ebook cached at the client device. The indexed (i.e., currently live) ebook in the ebook repository 122 is of a different version than the version at the client device 140, so the pagination might be different. In this situation, after the server layer support module 134 receives the client device's request for layer data (which includes an indication of the particular page), the server layer support module 134 uses the position validation service to translate the content locations for that page. Specifically, the position validation service translates the content locations for the page specified by the client device 140 (which is associated with the client device's version of the ebook) to the content locations for a (possibly different) page that is associated with the indexed version of the ebook. Layer data for the content locations associated with the indexed ebook is then obtained from the layer data repository 126. The position validation service is then used again to translate the content locations for the obtained layer data from the indexed ebook to the version of the ebook being accessed by the client device 140. The layer data with the modified locations is then sent to the client device 140.

As another example, assume that a client device 140 saves layer data associated with particular content (“annotated content”) in an ebook cached at the client device. The indexed (i.e., currently live) ebook in the ebook repository 122 is of a different version than the version at the client device 140, so the pagination might be different. In this situation, after the server layer support module 134 receives the layer data (which includes an indication of the annotated content location) from the client device 140, the server layer support module 134 uses the position validation service to translate the annotated content location. Specifically, the position validation service translates the location for the annotated content specified by the client device 140 (which is associated with the client device's version of the ebook) to the annotated content location that is associated with the indexed version of the ebook. The layer data provided by the client device 140 is then saved in the layer data repository 126 associated with the modified position.

The position validation service keeps track of layer data positions within ebooks (specifically, positions of ebook content associated with layer data). Position information includes, for example, page information and original scanjob information (e.g., information regarding the scanning of the underlying book to create the ebook). Page information includes, for example, a volume (ebook) page ID and a volume structured page ID. Scanjob information includes, for example, a scanjob ID and a scanjob page ID. Position information can also include a volume ID, the content before the annotated content, the annotated content itself, and the content after the annotated content. In one embodiment, position information is used to localize a layer data position within an old version of an ebook within a new version of the same ebook. Text alignment is then performed (using, for example, the Associated Ebook Text item in Table 1) to calculate an exact position. Thus, a portion of the new version that corresponds to a portion of the old version can be determined.

User layer settings repository 128 includes information concerning which layers a user has “installed.” For example, the user layer settings repository 128 includes, for each user ID, a list of layers that user has installed (if any). In one embodiment, the user layer settings repository 128 also includes a default list of installed layers for use with users who are anonymous (e.g., have not logged in). Installation of a layer indicates that the user wants to use that layer at some point in time, although not necessarily all of the time (an installed layer can be disabled). In one embodiment, installation of a layer does not indicate that the module for that layer is actually present on client device 140. Since one person can use multiple devices to read ebooks, user layer settings are stored at the repository 120. If a user wants to use a particular layer on a particular client device 140, the module for that layer will need to be present on that device. In another embodiment, a graphical user interface lists layers that are available for installation. The user installs/uninstalls these layers by checking/unchecking various boxes. These settings are then stored in the user layer settings repository 128.

The browser module 148 enables the user to access web-based content, such as the social network functionality provided by social network server 150, via network 110. Numerous browsers are publicly available for use with client devices 140, such as GOOGLE CHROME™. The browser module 148 may be a stand-alone software application or it may be embedded within another application/module, such as the ereader module 142. In one embodiment, the browser module 148 is specialized software (such as an app) designed to enable access to just the social network functionality provided by social network server 150.

The social network server 150 includes one or more computers that host a social network, such as GOOGLE+™. The social network has one or more social graphs that describe relationships among people and other entities. In the embodiment shown, the social network server 150 includes an interface module 152, a permissions module 154, a user data repository 156, and a post repository 158. Other embodiments of the social network server 150 include different and/or additional modules. In addition, the functions may be distributed among the modules in a different manner than described herein.

The interface module 152 provides UI controls to a client device 140 (via network 110) to enable a user to interact with the social network. For example, the interface module 152 may provide UI controls for a user to login to a user account by providing a user ID (e.g., a registered email address) and corresponding password. Information about user accounts is stored in the user data repository 156. In one embodiment, the data stored for each user account includes: a user ID, a password, user IDs of user accounts associated with the user account (e.g., a social graph), and profile information (e.g., name, age, interests, etc.). Once a user is logged into a user account, the user can access the social network content provided by the social network server 150.

The interface module 152 also provides a UI interface to the client device 140 (via network 110) to enable a user to add content (“posts”) to the social network. Depending on the embodiment, posts can include one or more different types of media content (e.g., text, audio, photos, video, and the like). When a post is made, the user interface module 152 stores the post in the post repository 158. Posts stored in the post repository 158 may include metadata. In one embodiment, each post includes metadata indicating a post ID, a user ID, and access permission data. The post ID and user ID uniquely identify the post and the post's author in the social network respectively. The access permission data controls which user IDs within the social network can view and/or comment on the post.

The interface module 152 also provides an application programming interface (API) for the social network. The social network API provides an interface for other modules and applications to interact with the social network. In one embodiment, the social network API includes functions that enable the ereader module 142 of a client device 140 to automatically make posts to the social network as well as access posts stored in the post repository 158.

The permissions module 154 manages access permission data for posts in the post repository 158 and determines whether a request received from the client device 140 to access a post should be granted or denied. In one embodiment, the interface module 152 provides UI controls to enable a user to place user accounts to which the user's user ID is connected into groups. For example, the user may have a “family” group and a “work colleagues” group. When creating a post to the social network, the interface module 152 provides UI controls at the client device 140 (via network 110) to enable the user to select one or more groups to give permission to view and/or comment on the post.

The ereader module 142 of the client device 140 requests access to a post from the social network by sending a user ID and a post ID to the social network server 150, via network 10. The permissions module 154 compares the user ID to the access permission data associated with the post ID. If the access permission data indicates that the user ID has permission to access the post, the post content is sent to the client device 140, via network 110. In one embodiment, a user ID only has permission to access a specific post if that post's permission data explicitly lists the user ID (a whitelist approach). For example, a student wishing to share a textbook annotation with a study group indicates which contacts on the social network are in the study group (or selects a pre-defined list such as a GOOGLE+CIRCLE™ that includes the members of the group) and the resulting social network post's permission data includes a whitelist containing the user IDs of each member of the group. In another embodiment, identifiers for one or more pre-defined lists of users are stored in the permission data for posts, rather than individual user IDs. When a user requests access to the post, the user's user ID is compared to the pre-defined lists indicated in the permission data. If the user's user ID is included in one or more of the pre-defined lists, the user is permitted to access the post. Thus, once the user has been added to a pre-defined list, the user can access all posts that indicate members of that pre-defined list have permission to access, even those posts that were made before the user was added to the pre-defined list. In a further embodiment, permission is assumed to be granted unless the permission data explicitly lists the user ID as not having permission (a blacklist approach). For example, a user adds an annotation to cookery book suggesting an improvement to a recipe. The user shares the annotation publicly, but indicates a second user should not have access as the two users recently had an argument. In other embodiments, combinations of whitelists and blacklists are used. For example, a group of user IDs (e.g., a post author's “family” group) may be given general access permission to a post (and corresponding annotation) regarding possible recipes for a party from a book, but a specific member of the group (e.g., a family member for whom the party is being planned as a surprise) may be explicitly blocked from access.

The processing server 130 includes an ebook support module 132 for handling ebook-related requests, a server layer support module 134 for handling layer-related requests, a server available-layers module 136 for determining which layers are available, an available layer data module 138 for determining which layer data is available, and a social network module 139 for managing interaction between layers and social network server 150. In one embodiment, the processing server 130 includes a computer (or set of computers) that communicates with repository 120, client device 140, and social network server 150 and processes data (e.g., by executing the ebook support module 132, the server layer support module 134, the server available-layers module 136, the available layer data module 138, and the social network module 139). In one embodiment, the processing server 130 includes a web server that responds to requests from the client device 140. Other embodiments of the processing server 130 include different and/or additional modules. In addition, the functions may be distributed among the modules in a different manner than described herein.

The ebook support module 132 handles ebook-related requests. Specifically, the ebook support module 132 receives requests from the ereader module 142 and responds to them accordingly. One type of request is for ebook metadata. Another type of request is for ebook content.

The server layer support module 134 handles layer-related requests. Specifically, the server layer support module 134 receives requests from the client layer support module 144 and responds to them accordingly. One type of request is for a list of available layers. Another type of request is for layer data.

The server available-layers module 136 determines which layers are available for a specified user to use with a specified ebook. Specifically, the server available-layers module 136 takes as input a user ID and an ebook ID and outputs a list of layers that are available for the user ID to use with the specified ebook. The server available-layers module 136 uses the user ID to determine which layers the user has installed (stored in the user layer settings repository 128). If a user ID is not provided (e.g., the user is anonymous or has not logged in), then a default list of installed layers is used (stored in the user layer settings repository 128).

The server available-layers module 136 uses the ebook ID to determine any layer filtering information such as a blacklist, whitelist, and/or add-list (if any) associated with the ebook (stored in ebook metadata in the ebook repository 122). The server available-layers module 136 then assembles a list of available layers by filtering the list of available layers using the layer filtering information. For example, the filtering may start with the installed layers, keep any layers that are on the whitelist (if a whitelist exists), remove any layers that are on the blacklist and not on the whitelist (if a blacklist exists), and add any layers that are on the add-list (if an add-list exists). If neither a blacklist nor a whitelist nor an add-list exists, then the assembled list includes all of the installed layers. In one embodiment, wildcards can be used in the blacklist, whitelist, and/or add-list. For example, a blacklist that contains only a wildcard would cause all layers to be removed (unless the layers are on the whitelist). The server available-layers module 136 outputs the remaining layers as a list of available layers (including layer metadata such as what type of ebook content a particular layer is applicable to and which display modes are supported by a particular layer). Note that this list of layers is dependent on the specific ebook being accessed by the client device 140.

The available layer data module 138 determines which layer data (e.g., annotations or entity information) is available for a specified user and specified pages of a specified ebook. Specifically, the available layer data module 138 takes as input a user ID, an ebook ID, a content range (e.g., a portion of the ebook), and an indication of which type of layer data is desired and outputs layer data that is available for the user ID, the ebook ID, the content range, and the indicated type. The available layer data module 138 uses the user ID, the ebook ID, and the server available-layers module 136 to determine which layers are available for the specified user to use with the specified ebook. The available layer data module 138 then obtains the layer data (stored in the layer data repository 126) associated with the available layers, the specified user, the specified ebook, and the specified content range. If a user ID is not provided (e.g., the user is anonymous or has not logged in), then the available layer data module 138 obtains the layer data (stored in the layer data repository 126) associated with the available layers, “all users” (e.g., anonymous users or the general public), the specified ebook, and the specified content range. The available layer data module 138 then outputs this layer data. In one embodiment, the available layer data module 138 interacts with the permissions module 154 of social network server 150 (via network 110) in order to determine what layer data is available for a specified user ID.

The social network module 139 manages interactions between layers and the social network server 150. Specifically, the social network module 139 makes annotations associated with ebooks and any comments associated with annotations available to both the ereader module 142 (i.e., within the ereader environment) and the browser module 148 (i.e., within the web-based, social network environment). Once an annotation has been shared to a social network, the social network module 139 retains synchronization between the annotation and the corresponding social network post, making comments added to the social network post available within the ereader environment. Additionally, if the corresponding social network post is edited or deleted, the annotation is amended accordingly. Thus, the social network module 139 improves the social aspects of reading within the ereader environment. For example, book clubs and study groups can read collaboratively. Further, readers can choose to share their thoughts and comments on a book publicly to provide advice to other readers, to obtain feedback on their own analyses, to make connections with other like-minded readers, etc. The functionality of the social network module 139 is described in further detail below with reference to FIG. 5.

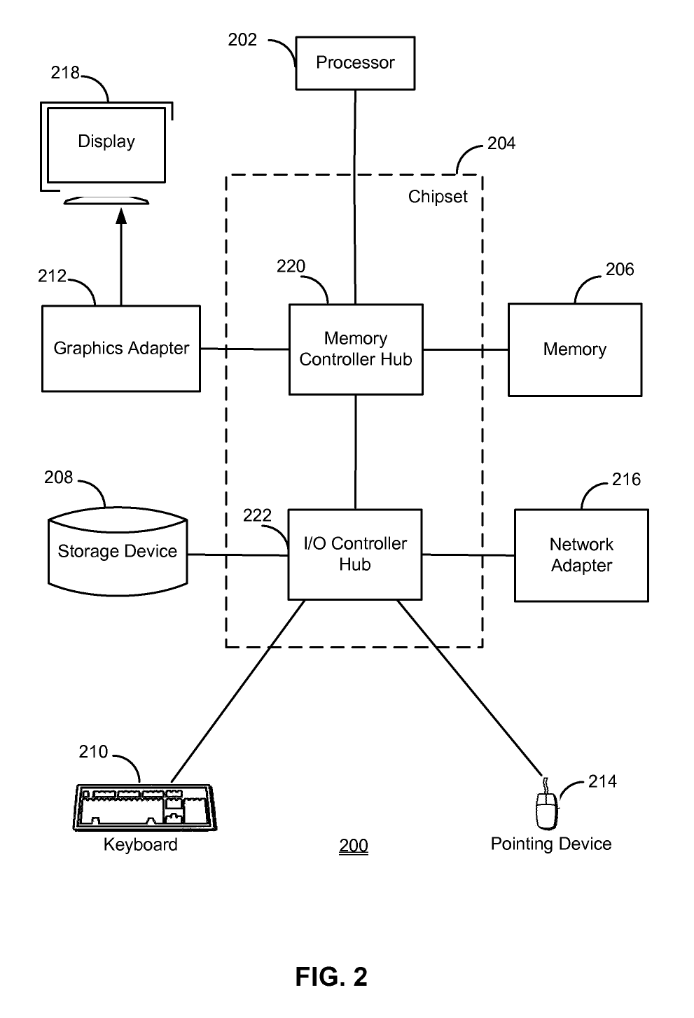

FIG. 2 is a high-level block diagram illustrating an example of a computer 200 for use as a repository 120, a processing server 130, a social network server 150, and/or a client device 140 in accordance with one embodiment. Illustrated are at least one processor 202 coupled to a chipset 204. The chipset 204 includes a memory controller hub 250 and an input/output (I/O) controller hub 255. A memory 206 and a graphics adapter 213 are coupled to the memory controller hub 250, and a display device 218 is coupled to the graphics adapter 213. A storage device 208, keyboard 210, pointing device 214, and network adapter 216 are coupled to the I/O controller hub 255. Other embodiments of the computer 200 have different architectures. For example, the memory 206 is directly coupled to the processor 202 in some embodiments.

The storage device 208 includes one or more non-transitory computer-readable storage media such as a hard drive, compact disk read-only memory (CD-ROM), DVD, or a solid-state memory device. The memory 206 holds instructions and data used by the processor 202. The pointing device 214 is used in combination with the keyboard 210 to input data into the computer system 200. The graphics adapter 213 displays images and other information on the display device 218. In some embodiments, the display device 218 includes a touch screen capability for receiving user input and selections. The network adapter 216 couples the computer system 200 to the network 110. Some embodiments of the computer 200 have different and/or other components than those shown in FIG. 2. For example, the repository 120 and/or the processing server 130 can be formed of multiple blade servers and lack a display device, keyboard, and other components, while the client device 140 can be a notebook or desktop computer, a tablet computer, or a mobile phone.

The computer 200 is adapted to execute computer program modules for providing functionality described herein. As used herein, the term “module” refers to computer program instructions and/or other logic used to provide the specified functionality. Thus, a module can be implemented in hardware, firmware, and/or software. In one embodiment, program modules formed of executable computer program instructions are stored on the storage device 208, loaded into the memory 206, and executed by the processor 202.

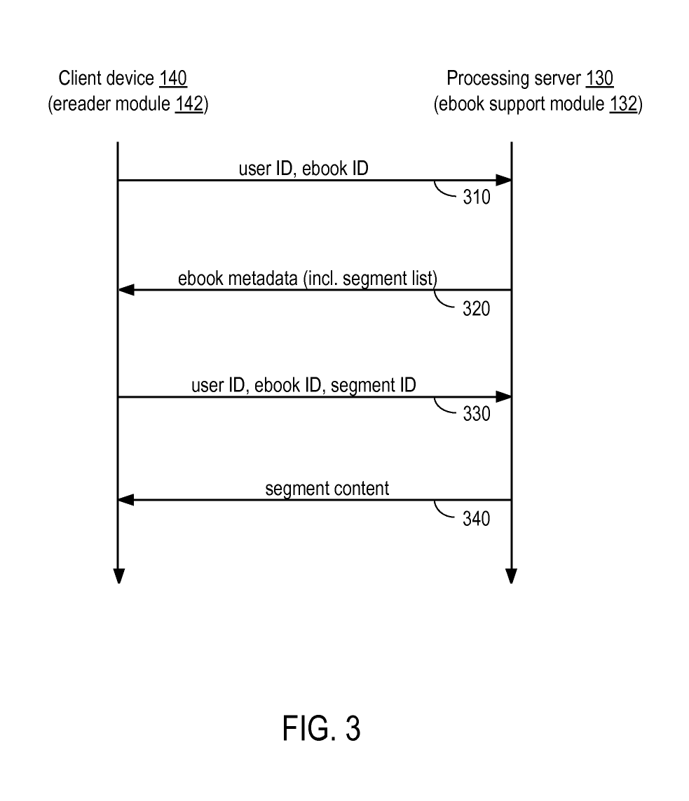

FIG. 3 is a sequence diagram illustrating steps involved in transferring ebook information according to one embodiment. In step 310, the ereader module 142 associated with the client device 140 sends a user ID and an ebook ID to the ebook support module 132 associated with the processing server 130. The ebook support module 132 determines (not shown) whether the specified user is allowed to read the specified ebook. If the user is allowed to read the ebook, then, in step 320, the ebook support module 132 sends metadata for the specified ebook to the ereader module 142. The metadata includes, among other things, a list of segments into which the ebook's content is divided.

In step 330, the ereader module 142 sends a user ID, an ebook ID, and a segment ID to the ebook support module 132. The ebook support module 132 determines (not shown) whether the specified user is allowed to read the specified segment of the specified ebook. If the user is allowed to read the ebook segment, then, in step 340, the ebook support module 132 sends content for the specified ebook to the ereader module 142. The content sent corresponds to the specified segment. In one embodiment, the segment content is transferred in an encrypted state and then decrypted at the client device 140.

In the embodiment illustrated in FIG. 3, the ebook support module 132 does not send all of the content for the specified ebook at one time to the ereader module 142. Instead, content is transferred segment by segment (step 340) as each segment is requested (step 330). In this embodiment, the client device 140 must be online so that the ereader module 142 can periodically request and receive segment content as needed from the ebook support module 132.

In one embodiment, after the requested segment is sent, additional segments for the same ebook are also sent, even if they have not been requested. In this way, if the user tries to view a page outside the requested segment, the appropriate segment might already exist on the client device 140 and need not be requested. If the appropriate segment already exists on the client device 140, then the reading experience is improved, since the user need not wait for the appropriate segment to be sent to the client device 140. Also, additional segments are available for viewing offline. The additional segments that are sent can, for example, be adjacent to the requested segment (in terms of pages contained therein) or start at the beginning of the ebook and move forward throughout the entire ebook (until all segments have been sent to the ereader module 142). In a different embodiment (not shown), one request from the ereader module 142 to the ebook support module 132 results in the ebook support module 132 sending all of the content for the specified ebook at one time. In this embodiment, the client device 140 need not be online after the initial request and receipt of content.

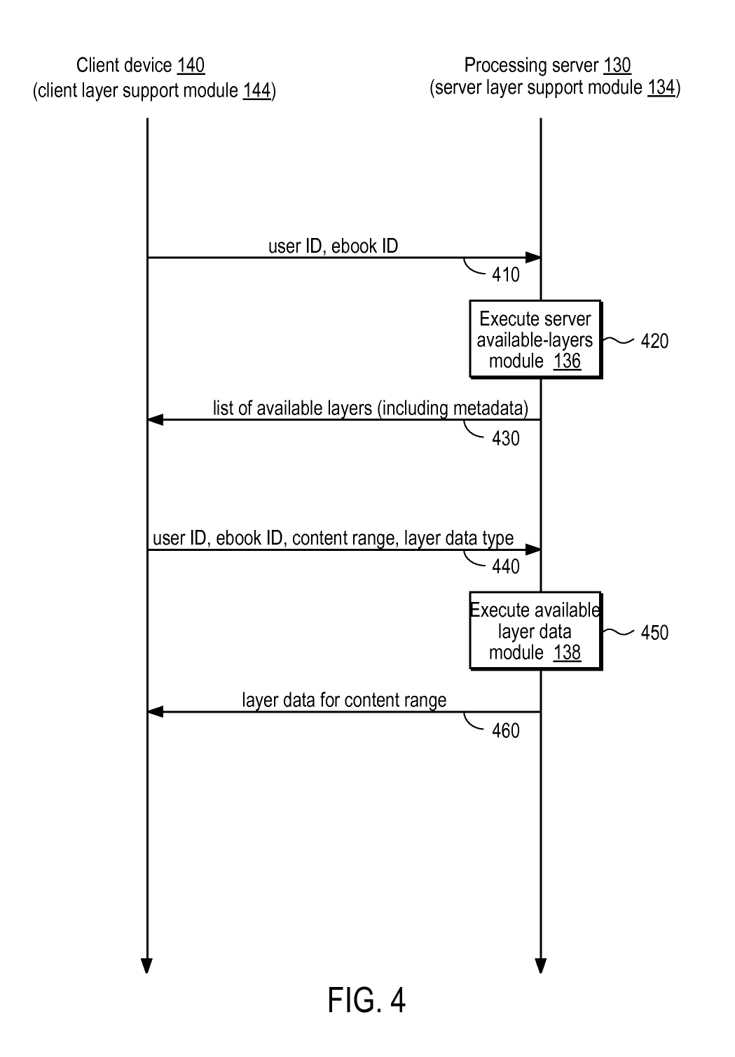

FIG. 4 is a sequence diagram illustrating steps involved in transferring layer information according to one embodiment. In step 410, the client layer support module 144 associated with the client device 140 sends a user ID (optional) and an ebook ID to the server layer support module 134 associated with processing server 130. The server layer support module 134 executes 420 the server available-layers module 136 to determine which layers are available for the specified user (or the default/anonymous user if a user ID is not provided) to use with the specified ebook. In step 430, the server layer support module 134 sends a list of available layers to the client layer support module 144. The list includes, among other things, layer metadata such as what types of ebook content a particular layer is applicable to and what display modes are supported by a particular layer. The type of the ebook content can be a data type (e.g., text, image, video, or audio), an annotation type (e.g., the layer that created the annotation), or an entity type (e.g., date, person, or geographic location).

In step 440, the client layer support module 144 sends, to the server layer support module 134, a user ID, an ebook ID, a content range, an indication of which type or types of layer data is desired, and an indication of a desired language. The user ID and desired language are optional, with defaults being used if one or both are not provided. The server layer support module 134 executes 450 the available layer data module 138 to determine which layer data (e.g., user added comments) are available for the specified user (or the default/anonymous user if a user ID is not provided) and the specified content of the specified ebook. In step 460, the server layer support module 134 sends layer data for the specified ebook to the client layer support module 144. The layer data corresponds to the specified pages and is in the desired language (if specified and available to the server; otherwise, a default language is used).

In one embodiment, after the layer data for the specified content range is sent, layer data for additional content ranges in the same ebook is also sent, even if layer data for those content ranges has not been requested. In this way, if the user tries to view a page outside of the requested content range, the appropriate layer data might already exist on the client device 140 and need not be requested. If the appropriate layer data already exists on the client device 140, then the reading experience is improved, since the user need not wait for the appropriate layer data to be sent to the client device 140. Also, additional layer data is then available for viewing offline. The additional layer data that is sent can, for example, be adjacent to the requested layer data (in terms of pages that reference it) or start at the beginning of the ebook and move forward throughout the entire ebook (until all layer data has been sent to the ereader module 142). In a different embodiment (not shown), one request from the ereader module 142 to the ebook support module 132 results in the ebook support module 132 sending all of the layer data for the specified ebook at one time. In this embodiment, the client device 140 need not be online after the initial request and receipt of content.

FIG. 5 is a high-level block diagram illustrating the social network module 139 of the processing server 130 shown in FIG. 1, according to one embodiment. As shown, the social network module 139 includes an interaction module 510, a posting module 520, a synchronization module 530, and a filtering module 540. Other embodiments of the social network module 139 include different and/or additional modules. In addition, the functions may be distributed among the modules in a different manner than described herein.

The interaction module 510 establishes and manages a connection with the interface module 152 of the social network server 150. The interaction module 510 utilizes the social network API provided by the interface module 152 of the social network server 150 to enable the social network module 139 to post to the social network, access social network posts in the post repository 158 and otherwise interact with the social network. In one embodiment, when a layer that provides social network functionality is launched (e.g., a Margin Notes layer), the interaction module 510 requests login details for the user's social network account (e.g., username and password) from the client layer support module 144 of the client device 140.

The posting module 520 facilitates sharing of annotations by making automatic posts using the user's social network account. When the user elects to share an annotation, the client layer support module 144 sends a request to share the annotation to the posting module 520, via network 110. The request received by the posting module 520 includes the body of the annotation to be shared and contextual information (e.g., a corresponding content range), and optionally includes access permission data. In one embodiment, the user may elect to have all annotations the user creates automatically shared to the social network. In this way, the user experience is streamlined as the user does not need to elect to share each annotation individually.

On receiving a request to share an annotation, the posting module 520 uses the social network API to automatically create a post on the social network. The post is stored in the post repository 158 and includes a post ID, which uniquely identifies the post on the social network, and a body (i.e., a displayable portion) that contains the annotation and, optionally, contextual information (e.g., an indication of the corresponding ebook portion, such as ebook ID, page number, paragraph number, etc.). For example, if a user adds a text comment to page 27 of a book, the post module 520 automatically creates a post on the social network (stored in the post repository 158) including the text comment as well as contextual information indicating the book and the portion of that book to which the comment corresponds.

In one embodiment, the posting module 520 leverages the functionality of the permissions module 154 of social network 150 using the social network API to enable users to control who can see their shared annotations. Thus, when a user shares an annotation, the client layer support module 144 provides UI controls that enable the user to select access permissions for the annotation. For example, the user may set access permission for the annotation to: private (just the user); friends; a subset of friends (e.g., a GOOGLE+™ circle for a book club); public (anybody), etc. In one embodiment, the user can set a default set of access permissions to be used for all annotations. In this way, the user experience is improved as the user is not required to explicitly provide access permissions for every annotation.

In one embodiment, the posting module 520 includes a link to the ebook in the post made to the social network. A user browsing the social network using the browser module 148 of a client device 140 may click or otherwise select the link to be directed to the ebook. For example, when the user clicks on the link in the social network post, the browser module 148 executes a Java applet ereader module 142 and attempts to open the ebook to which the annotation corresponds. If the user has permission to view the ebook (e.g., the user owns a copy, or the ebook is public domain) then the ebook is displayed in the ereader module 142, along with annotation and any corresponding comments. In one embodiment, the ereader module 142 automatically opens the ebook to the portion (e.g., chapter, page, etc.) to which the annotation corresponds.

If the user does not have permission to view the ebook, a variety of actions can be triggered, depending on the configuration of the ereader module 142 and/or options set by the publisher of the ebook and stored in the layer data repository 126. In one embodiment, the browser module 148 of the client device 140 is automatically directed to a webpage where the user can purchase the ebook. The publisher of the ebook may provide a discount to users that purchase the ebook from this webpage. The publisher may also reward users whose shared annotations lead to ebook sales, for example, by offering a discount on future purchases of ebooks from the publisher. In another embodiment, publishers can provide limited access ebooks for users clicking on links within annotations. For example, by allowing the user to access the ebook for a limited time (e.g., 1 hour), access just the chapter to which the annotation corresponds, access just the specific portion to which the annotation corresponds, etc. The user may be directed to a webpage to purchase the ebook if the user doesn't qualify to view the portion of the book for free (e.g., the user has previously accessed the ebook for the limited amount of time allowed by the publisher).

The synchronization module 530 maintains synchronization between the annotation stored in the annotation repository 129 and the corresponding social network post in the post repository 158. In one embodiment, the synchronization module 530 adds metadata to the annotation indicating the post ID of the corresponding social network post. When the annotation is activated (e.g., by a user selecting it), the client layer support module sends the post ID to the synchronization module 530 with a request for any comments associated with the post ID. On receiving such a request, the synchronization module 530 queries the social network server 150 for any such comments using the social network API and sends any such comments to the client layer support module 144 for display. In this manner, the user can view the initial annotation in conjunction with any comments made on the social network without leaving the ereader environment. The client layer support module 144 may provide UI controls to enable the user to expand (display) and collapse (hide) comments on the annotation. When the comments on annotation are collapsed, the ereader module 142 optionally provides an indication of how many comments are associated with the annotation, e.g., by displaying a numeral next to the annotation. In another embodiment, rather than retrieving the body of all comments associated with the post ID, the synchronization module 530 queries the social network server 150 using the social network API for aggregate information, such as a total number of comments, a number of comments in a specified time period (e.g., the last week), a number of comments since the last such query, and the like. The aggregate information is displayed in the layer in conjunction with the electronic book (e.g., as a numeral next to an annotation indicating a number of comments). The synchronization module 530 obtains the body of one or more comments in response to user input requesting to view the one or more comments.

In one embodiment, when a social network post that corresponds to an annotation is edited or deleted, the social network server 150 sends a notification, including the social network post's post ID, to the synchronization module 530 of the processing server 130. The synchronization module 530 identifies the corresponding annotation in the annotation repository 129 using the post ID. If the post was edited, the synchronization module 530 updates the content of the corresponding annotation to retain synchronization between the post and annotation. If the post was deleted, the synchronization module 530 deletes the corresponding annotation. Alternatively, the synchronization module 530 edits metadata associated with the corresponding annotation to unshare the annotation, thereby making it only available to the author (who may elect to reshare the annotation at a later time). In one embodiment, the user is given a choice between deleting an annotation entirely and unsharing it when the corresponding social network post is deleted.

In an alternative embodiment, the social network server 150 does not send notifications to the processing server 130. Instead, the synchronization module 530 polls the social network server 150 at regular intervals (e.g., hourly, once a day, etc.) for updated posts using the social network API. Alternatively, the social network server 150 can be polled to check for updates to the post corresponding to a specific annotation when that annotation is requested for display by a client device 140.

In one embodiment, a shared annotation stored in the annotation repository 129 includes a post ID identifying the corresponding post in the post repository 158 rather than the body of the annotation. When a request to display the annotation at the client device 140 (either automatically, or responsive to user input), the client layer support module 144 requests the body of the annotation as well as the associated comments from the synchronization module 530. In this way, duplication of data in the annotation repository 129 and post repository 158 is reduced.

In one embodiment, the client layer support module 144 provides UI controls to enable users to comment on shared annotations from within the ereader environment, as well as users being able to comment on annotations in the social network environment. The synchronization module 530 leverages the social network API to add comments to the corresponding post in the post repository 158. For example, a user enters a comment on an annotation within the ereader environment on the client device 140. The client layer support module 144 extracts the corresponding post ID from the annotation and sends the post ID along with the user comment to the synchronization module 530, via network 110. The synchronization module 530 then uses the social network API to add the comment to the correct post in the post repository 158 based on the post ID. In this way, users can both view and comment on annotations using either the ereader module 142 (i.e., from within the ereader environment) or the browser module 148 (i.e., from within the social network environment), and the comments are entirely synchronized across both environments.

In some embodiments, after the synchronization module 530 queries the social network server 150 for comments corresponding to an annotation or post ID, and before sending the comments to the client layer support module 144, the synchronization module examines the comments received for references to user IDs. On detecting a user ID within a comment, the synchronization module 530 uses the social network API to determine whether the detected user ID is currently permitted to access the post to which the comment corresponds. If the user ID does not currently have permission to access the corresponding post, the synchronization module 530 uses the social network API to modify the post access permissions to allow the referenced user ID to access the corresponding post. For example, if one member of a study group during discussion of a difficult concept in a textbook comments “Joe Bloggs explained this to me last week,” and Joe Bloggs is not a member of the study group, the synchronization module 530 adds Joe Bloggs to the list of users able to view and comment on the social network post. The synchronization module 530 may also send a notification to the user ID and/or the post's author (e.g., by sending an email to an address registered to the user ID and/or author). Alternatively, the author may be first notified and provided with an option to approve or deny the suggestion to grant access permission to the user ID.

The filtering module 540 provides UI controls to the client device 140 to enable the user to filter annotations to display based on one or more filter criteria. For example, the user may select filter criteria such as: all annotations available; just annotations authored by friends within the social network; just annotations authored by a subset of friends within the social network (e.g., a particular circle within GOOGLE+™), or just the user's own annotations. In some embodiments, annotations can also be filtered by filter criteria such as: the date the annotation was created; location metadata associated with the annotation; a feedback rating associated with the annotation; and the like.

In one embodiment, on receiving a request for annotations from the client device 140, the filter module 540 queries the annotations repository 129 for available annotations corresponding to the currently displayed content that meet the criteria provided (e.g., by providing the user's user ID, the current book ID and page number, and the filter criteria). For each annotation in the annotations repository 129 that corresponds to the currently displayed portion, the filter module 540 examines the annotation for an included social network post ID identifying a social network post that corresponds to the annotation. If no corresponding social network post is identified (e.g., if the annotation has not been shared) then the annotation is sent to the client device only if it was authored by the user. If a social network post is identified, filter module 540 interacts with the permissions module 154 using the social network API to determine whether the user has permission to view that post (e.g., by comparing the user's user ID with a permissions list associated with the post). If the user has permission to view the post, the annotation and corresponding social network comments are sent to the client device 140 for display. In one embodiment, a copy of the permission data from the social network is stored in the annotations repository 129. Thus, the filter module 540 can determine whether a user has permission to view an annotation directly, without the need to query the permissions module 154 of the social network server 150.

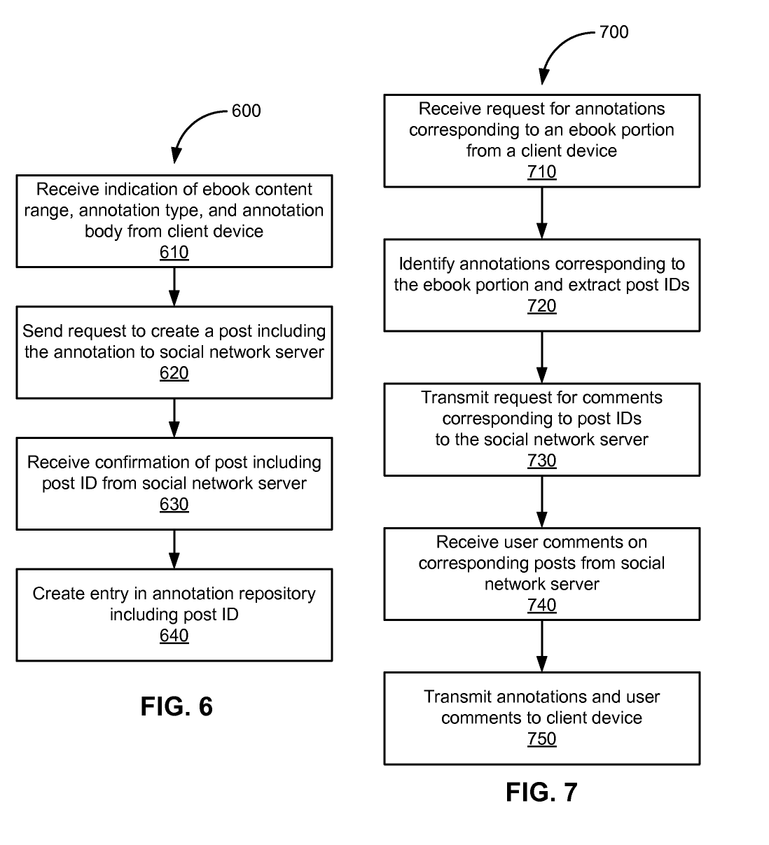

FIG. 6 is a flowchart illustrating a method 600 for creating an annotation that is synchronized between an ereader environment and a social network, according to one embodiment. FIG. 6 attributes the steps of the method 600 to the processing server 130. However, some or all of the steps may be performed by other entities. In addition, some embodiments may perform the steps in parallel, perform the steps in different orders, or perform different steps.

Initially, in step 610, the processing server 130 receives an indication of an ebook and a content range (e.g., ebook ID and paragraph number), a type for the annotation, and the annotation body, from a client device 140. The indication of the range of ebook content identifies a specific portion of a particular ebook to which the annotation corresponds. The annotation content may include text, audio, video, images, and the like. Typically, the annotation content is user generated, but in some embodiments part or all of the annotation content can be created automatically by a layer.

At step 620, the processing server 130 uses the social network API to send a request, via the network 110, to create a post on the user's social network account. The request includes the annotation content and contextual data such as the ebook ID and content range. Thus, the request identifies a portion of an ebook to which the post corresponds. In one embodiment, the request also includes access permission data indicating which users on the social network, if any, should be given permission to view the post. Access permissions may be assigned by the permissions module 154 to allow specific subsets of the social network users (e.g., allowing all of the user's friends) or individuals to view the post. The permissions module 154 can also set access permissions negatively (a blacklist approach), e.g., John Smith may not view this post. On receiving a post request from the processing server 130, the social network server 150 creates a post in the post repository 158 that includes the annotation content and any contextual data provided. If access permission data was provided, the permissions module 154 applies the indicated access permissions to the post; otherwise, default access permissions are used.

At step 630, the processing sever 130 receives confirmation from the social network 150 that the requested post was successfully created. The confirmation includes a post identifier (post ID) that uniquely identifies the post on the social network. If the response received from the social network server 150 indicates the post was not successfully created (or no response is received) the processing server 130 can make a new request and/or send a notification of the failure to the client device 140.

At step 640, the processing server 130 creates an entry in the annotation repository 129 corresponding to the annotation. The processing server stores the post ID received from the social network server 150 in association with the annotation, thereby linking the annotation with the corresponding social network post such that when the annotation is accessed by the client layer support module 144 for display in a layer, the corresponding social network post can also be accessed. In one embodiment, the content of the annotation is not stored in the annotation repository 129. When the client layer support module 144 requests the annotation for display, the server layer support module 134 uses the post ID stored in the annotation repository 129 entry to obtain the annotation content from the corresponding social network post stored in the post repository 158.

FIG. 7 is a flowchart illustrating a method 700 for supporting annotated ebook content, according to one embodiment. FIG. 7 attributes the steps of the method 700 to the processing server 130. However, some or all of the steps may be performed by other entities. In addition, some embodiments may perform the steps in parallel, perform the steps in different orders, or perform different steps.

Initially, at step 710, the processing server 130 receives a request for annotations from the client layer support module 144 of a client device 140. The request includes an ebook ID and content range that identify a portion of a particular ebook for which annotations are requested. Optionally, the request also includes filtering criteria (e.g., only the user's own annotations, only annotations by friends, all available annotations, and the like). If no filter criteria are provided, default criteria are used (e.g., all available annotations). In one embodiment, the ebook ID and content range corresponds to the currently displayed content of the ereader module 142 of the client device 140. In other embodiments, the client layer support module 144 may request all annotations for the current page, current chapter, or current book being displayed by the ereader module 142.

At step 720, the available layer data module 138 identifies available annotations in the annotation repository 129 that correspond to the identified ebook portion and filter criteria. The server layer support module 134 then attempts to extract a post ID to identify a corresponding social network post for each of the identified annotations. If an annotation stored in the annotation repository 129 has been previously shared to the social network (as described above with reference to FIGS. 1, 2 and 6) then the annotation will include a post ID. Thus, the identified post corresponds to the annotation, and, hence, the identified post also corresponds to the identified ebook portion. If an annotation has not been shared, it will not include a post ID and the server layer support module 134 marks it as ready for transmission to the client device 140. In one embodiment, the synchronization module 530 of the social network module 139 compares the content of the annotation to the corresponding social network post and updates (e.g., edits or deletes) the annotation if the corresponding social network post has been modified.

At step 730, the social network module 139 uses the social network API to transmit a request for comments corresponding to the extracted post IDs to the social network server 150. In embodiments where the annotations stored in the annotation repository 129 do not contain the full content of the annotation (e.g., if only the post ID and content range information are stored), the social network module 139 also requests the content of the annotation from the social network server 150. In one embodiment, comments corresponding to an annotation are only requested from the social network server 150 when a user activates the annotation (e.g., by clicking on it).

At step 740, the social network module 139 receives the requested user comments and/or annotation content from the social network server 150. In one embodiment, the social network module 139 utilizes the social network API provided by the social network server 150 to compare a user ID associated with the client device 140 to access permission data. Thus, the social network module 139 only receives comments and annotation content that the user ID has permission to access. In an alternative embodiment, access permission is determined by the processing server 130.

At step 750, the identified annotation content and corresponding comments are transmitted for display at the client device 140. In embodiments where the full content of annotations is not stored in the annotations repository 129, the content of the identified posts (the annotations) and corresponding comments are transmitted to the client device 140. In this manner, all of the synchronized annotations corresponding to the identified portion of the electronic book that the user has permission to access can be displayed by a layer running within the ereader module 142. Further, any comments regarding the annotations on the social network are also synchronously displayed.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for automatically correcting errors in digital volumes. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein. The scope of the invention is to be limited only by the following claims.

1. A computer-implemented method for supporting annotated electronic book (“ebook”) content, comprising:
receiving, from a client device, a message, the message identifying a portion of an ebook;
identifying a post on a social network containing content for an annotation, the post corresponding to the identified portion of the ebook; and
transmitting, to the client device, the content contained by the identified post;
wherein the client device is adapted to display the content contained by the identified post in association with the portion of the ebook to which the post corresponds.

2. The computer-implemented method of claim 1, further comprising:
determining a set of layers available for use with the ebook, the layers in the set providing information associated with the ebook, different layers in the set providing different types of information, and a layer in the set adapted to display the content contained by the identified post in association with the portion of the ebook to which the post corresponds; and
providing the layer to the client device.

3. The computer-implemented method of claim 1, wherein identifying the post on the social network comprises:
identifying, in an annotation repository, an annotation corresponding to the identified portion of the ebook, the annotation including a social network post identifier identifying the post on the social network.

4. The computer-implemented method of claim 1, further comprising:
receiving, from the client device, an annotation by a user of the client device, and a second identifier of a second portion of the ebook to which the annotation corresponds;
sending, to the social network server, a request to create a post on the social network, the request comprising the annotation by the user;
receiving, from the social network server, a post identifier identifying the created post on the social network, the created post including the annotation by the user; and
storing the post identifier in association with the annotation in a repository.

5. The computer-implemented method of claim 4, wherein the request sent to the social network server further comprises access permission data indicating a subset of users of the social network that may view the created post.

6. The computer-implemented method of claim 5, further comprising:
receiving, from the social network server, a comment associated with the created post, the comment referencing a user of the social network who is not included in the subset of users; and
transmitting, to the social network server, a request to add the user of the social network to the subset of users that may view the created post.

7. The computer-implemented method of claim 1, further comprising:
transmitting, to the client device, one or more comments on the social network associated with the identified post;
wherein the client device is adapted to display the one or more comments in association with the identified post.

8. The computer-implemented method of claim 1, further comprising:
receiving, from a second client device, a request to access the electronic book;
selecting, responsive to the second client device not having permission to access the electronic book, at least one action from the group consisting of: a) providing a user of the second client device with an option to purchase the ebook; b) providing the second client device with access to a limited portion of the ebook; and c) providing the second client device with access to the ebook for a limited period of time; wherein the selecting is based on data provided by a publisher of the ebook; and
sending, to the second client device, instructions to implement the at least one selected action.

9. The computer-implemented method of claim 1, wherein the identified portion of the ebook is a whole ebook.

10. A computer system for supporting annotated electronic book (“ebook”) content, comprising:
a non-transitory computer-readable storage medium comprising executable computer program code for:
receiving, from a client device, a message, the message identifying a portion of an ebook;
identifying a post on a social network containing content for an annotation, the post corresponding to the identified portion of the ebook; and
transmitting, to the client device, the content contained by the identified post;
wherein the client device is adapted to display the content contained by the identified post in association with the portion of the ebook to which the post corresponds; and
a processor for executing the computer program code.

11. The computer system of claim 10, wherein the non-transitory computer-readable storage medium further comprises executable computer program code for:
determining a set of layers available for use with the ebook, the layers in the set providing information associated with the ebook, different layers in the set providing different types of information, and a layer in the set adapted to display the content contained by the identified post in association with the portion of the ebook to which the post corresponds; and
providing the layer to the client device.

12. The computer system of claim 10, wherein identifying the post on the social network comprises:
identifying, in an annotation repository, an annotation corresponding to the identified portion of the ebook, the annotation including a social network post identifier identifying the post on the social network.

13. The computer system of claim 10, wherein the non-transitory computer-readable storage medium further comprises executable computer program code for:
receiving, from the client device, an annotation by a user of the client device, and a second identifier of a second portion of the ebook to which the annotation corresponds;
sending, to the social network server, a request to create a post on the social network, the request comprising the annotation by the user;
receiving, from the social network server, a post identifier identifying the created post on the social network, the created post including the annotation by the user; and
storing the post identifier in association with the annotation in a repository.

14. The computer system of claim 10, wherein the non-transitory computer-readable storage medium further comprises executable computer program code for:
transmitting, to the client device, one or more comments on the social network associated with the identified post;
wherein the client device is adapted to display the one or more comments in association with the identified post.

15. A non-transitory computer-readable storage medium storing executable computer program code for supporting annotated electronic book (“ebook”) content, the computer program code comprising instructions for:
receiving, from a client device, a message, the message identifying a portion of an ebook;
identifying a post on a social network containing content for an annotation, the post corresponding to the identified portion of the ebook; and
transmitting, to the client device, the content contained by the identified post;
wherein the client device is adapted to display the content contained by the identified post in association with the portion of the ebook to which the post corresponds.

16. The non-transitory computer-readable storage medium of claim 15, wherein the executable computer program code further comprises instructions for:
determining, a set of layers available for use with the ebook, the layers in the set providing information associated with the ebook, different layers in the set providing different types of information, and a layer in the set adapted to display the content contained by the identified post in association with the portion of the ebook to which the post corresponds; and
providing the layer to the client device.

17. The non-transitory computer-readable storage medium of claim 15, wherein identifying the post on the social network comprises:
identifying, in an annotation repository, an annotation corresponding to the identified portion of the ebook, the annotation including a social network post identifier identifying the post on the social network.

18. The non-transitory computer-readable storage medium of claim 15, wherein the executable computer program code further comprises instructions for:
receiving, from the client device, an annotation by a user of the client device, and a second identifier of a second portion of the ebook to which the annotation corresponds;
sending, to the social network server, a request to create a post on the social network, the request comprising the annotation by the user;
receiving, from the social network server, a post identifier identifying the created post on the social network, the created post including the annotation by the user; and
storing the post identifier in association with the annotation in a repository.

19. The non-transitory computer-readable storage medium of claim 18, wherein the request sent to the social network server further comprises access permission data indicating a subset of users of the social network that may view the created post, and the executable computer program code further comprises instructions for:
receiving, from the social network server, a comment associated with the created post, the comment referencing a user of the social network who is not included in the subset of users; and
transmitting, to the social network server, a request to add the user of the social network to the subset of users that may view the created post.

20. The non-transitory computer-readable storage medium of claim 15, wherein the executable computer program code further comprises instructions for:
transmitting, to the client device, one or more comments on the social network associated with the identified post;
wherein the client device is adapted to display the one or more comments in association with the identified post.
